(19) United States
(12) Patent Application Publication
(10) Pub. No.: US 2018/0271347 A1
(43) Pub. Date: Sep. 27, 2018

(54) RELEASE LEVER FOR MAGNETIC SWEEPER WITH THREE-SIDED CHANNEL STRUCTURE

(71) Applicant: STEVEN JAY SNIDER, Grafton, OH (US)

(72) Inventor: STEVEN JAY SNIDER, Grafton, OH (US)

(21) Appl. No.: 15/825,850

(22) Filed: Nov. 29, 2017

Related U.S. Application Data
(60) Provisional application No. 62/429,382, filed on Dec. 2, 2016.

(51) Int. Cl. A47L 13/41

(52) U.S. Cl. CPC A47L 13/41; B03C 2201/28

(57) ABSTRACT

A magnetic tool for manipulated conveyance over a surface for magnetic collection of ferrous articles. This tool has a three-sided extruded channel, which cooperates with an opposing steel top plate to form a protective magnet housing for one or more magnets.

The extruded channel is configured to direct magnet flux downward to optimize the attraction efficiency of the tool.

Magnetic flux is further optimized by the use of multiple magnets in the channel housing of opposite polarity. The steel top plate channel also serves as the primary structural element of the tool for attachment of conveyance and manipulation means, such as an adjustable handle by means of an ACME collar and two axles for wheels.

The invention is the three-sided extruded channel, that has an incorporated track for a free-floating hinged release lever. The release lever has been designed specifically as a means of easily removing ferrous material attracted by the three-sided channel, that allows to pass through the magnetic field from the magnets. As a means of incorporating minimal mechanical friction, the magnets are allowed to remain in a static position within the housing. A free-floating release lever is incorporated via a hinge into the extruded housing as to create a space gap between the magnetic field and the ferrous materials collected when operated. This allows for easy removal of the ferrous material without the operator having to be in direct contact with it.

### FIELD OF THE INVENTION

The present invention pertains generally to magnets and magnetic devices and, more particularly, to magnetic hand tools with functional features, which cooperate with housed or mounted magnets and a free-floating hinged release lever, that can be used to release collected ferrous materials by normal gravitational pull.

### BACKGROUND OF THE INVENTION

Magnetic tools, such as hand tools, require some type of supported structure or housing for magnetized material, and other functional aspects such as a grip, conveyance such as wheels or other mechanism for performance of the tool. The type and purpose of the tool dictates the mounting or housing structure for the magnet, with a primary operational concern being that the magnetic flux is directed in the desired orientation relative to the tool. For example, in a hand-held magnetic tool with some type of grip, it is desirable that the magnetic flux be directed generally away from the grip to maximize the operational efficiency of the tool. In a hand-operated magnetic sweeper, such as described for example in U.S. Pat. No. 6,158,792, designed to pick up ferrous objects off the floor, it is desirable to have the magnetic flux directed downward by the housing which supports and surrounds the magnet or magnets.

Directing magnetic flux in one general direction typically requires that the magnet or magnets be shrouded or otherwise encapsulated on all sides but the desired flux direction. The magnetic sweeper described in U.S. Pat. No. 6,158,792 has three-sided magnet housing, with the top side directing the flux downward through an aluminum channel which protects the front and underside of the magnet. This downwardly directed flux tends to attract ferrous objects on the frontal surface of the magnet housing of the tool, rather than to the bottom surface of the magnetic housing. The rear facing surface of the magnet is left exposed. While this may direct the magnetic flux downward, attraction of sharp objects directly against the exposed magnet may result in chipping, breaking or soiling of the magnet, resulting in diminished performance of the tool. In this design, the three-sided channel, which serves as the magnet housing is attached to a support structure, the steel top plate, which, in turn, is attached to a handle via an ACME collar.

Then a ‘free-floating’-release lever is encapsulating the three-sided channel by use of a hinge, that is connected to the track portion of the three-sided channel. A ‘positioning ridge’ is added to the track portion of the three-sided channel to keep the ‘free-floating’-release lever from binding while operating in a fluid motion.

This adds to the complexity of the construction of the device and makes it possible to release collected ferrous materials over a collection drop area without the operator having to physically be in contact by hand, foot or otherwise and through the use of normal gravitational pull.

### BRIEF SUMMARY OF THE INVENTION

The present invention provides a magnetic sweeper tool with an integrated construction, which optimizes magnetic flux in a desired direction for maximum pick-up efficiency. In accordance with the principles of the invention, a magnetic sweeper has a three-sided channel, which houses one or more magnets in a generally planar arrangement, with an open side of the channel being covered by a steel top plate, which covers the remaining exposed surface of the magnet(s). The steel top plate serves both as the primary structural member of the magnetic sweeper tool, and to direct the magnetic flux downward away from the steel top plate toward a floor surface over which the tool is conveyed by wheels or other conveyance. The steel top plate covering the open side of the extruded channel and the exposed surface of the magnet(s) is of a different material then the channel, so as to not short the magnetic circuit within the housing formed by the extruded channel and steel top plate. As the primary structural member of the tool, the steel top plate further functions to support two axles for the mounting of wheels at opposite ends of the plate as well as a female ACME collar. This design allows for the attachment of two wheels and a handle or other manipulation part. In one embodiment, a wheel axle is attached to the bottom of the steel top plate at each end. A manipulation handle is attached directly to the steel top plate, preferably at a mid-point along the top of the plate by means of an ACME collar.

A ‘free-floating’-release lever is connected to the extruded housing. Its design, in combination with the track portion of the extruded housing and the positioning ridge within the extruded housing, make it so that there is no binding of the ‘free-floating’-release lever while it can be used in a fluid motion in the release of ferrous materials.

These and other aspects of the invention are described herein in detail with reference to the accompanied Figures, which are denoted with reference numbers associated with the various components, parts and assemblies of the invention.

The invention is the three-sided extruded channel, that has an incorporated track for a free-floating hinged release lever. The release lever has been designed specifically as a means of easily removing ferrous material attracted by the three-sided channel, that allows to pass through the magnetic field from the magnets. As a means of incorporating minimal mechanical friction, the magnets are allowed to remain in a static position within the housing. A free-floating release lever is incorporated via a hinge into the extruded housing as to create a space gap between the magnetic field and the ferrous materials collected when operated. This allows for easy removal of the ferrous material without the operator having to be in direct contact with it.

### DESCRIPTION OF THE FIGURES

FIGS. 1(A-D) is a perspective view of a Magnetic Sweeper with three-sided extruded channel and free-floating Release Lever.

FIG. 2 is an exploded perspective view of the magnetic tool of FIG. 1.

FIG. 3 is a perspective top view of the main body consisting of a 14-inch long flat bar of steel 6 to which the right and left axles 9 are welded along with the ACME collar 3.

FIG. 4 is a perspective view of the main body as described in [0008] rotated about axis 180° showing the ACME collar 3, the axles 9 as well as multiple ceramic magnets 13 placed under the flat bar of steel 6 with magnetic shielding strips 10.

FIG. 5 is a perspective view of the extruded channel 11 housing the main body as described under FIG. 3 and FIG. 4 above. The extruded channel 11 has a track portion 14 that allows for the release lever FIG. 6 to pivot on it. This ‘track portion’ 14, that accepts the ‘hinge portion’ 15 of the ‘free-floating’-release lever FIG. 6 to slide into/connect to the extruded channel 11. The ‘positioning ridge’ 16 keeps the track portion 14 from binding while creating a fluid motion of the ‘free-floating’-release lever FIG. 6.

FIG. 6 is a perspective view of the “free floating”-release lever 5 that pivots along the track portion 14 of the extruded channel FIG. 5 that houses the main body FIG. 4. The ‘free-floating’-release lever 5 has a ‘hinge portion’ 15 to allow it to be connected freely to the track portion 14 of the extruded housing.

FIG. 7 is a perspective view of the main body as described in [0008] rotated about axis 180° showing the ACME collar 3, the axles 9 as well as two ceramic magnets 13 placed under the flat bar of steel 6 with magnetic shielding strips 10 with indication of the North and South poles and the direction of the magnetic flux.

FIG. 8 is a cross-cut view of the main body with three-sided extruded channel and free-floating release lever without the ACME collar. The individual parts have been described above under [0001-0012].

### DETAILED DESCRIPTION OF THE INVENTION

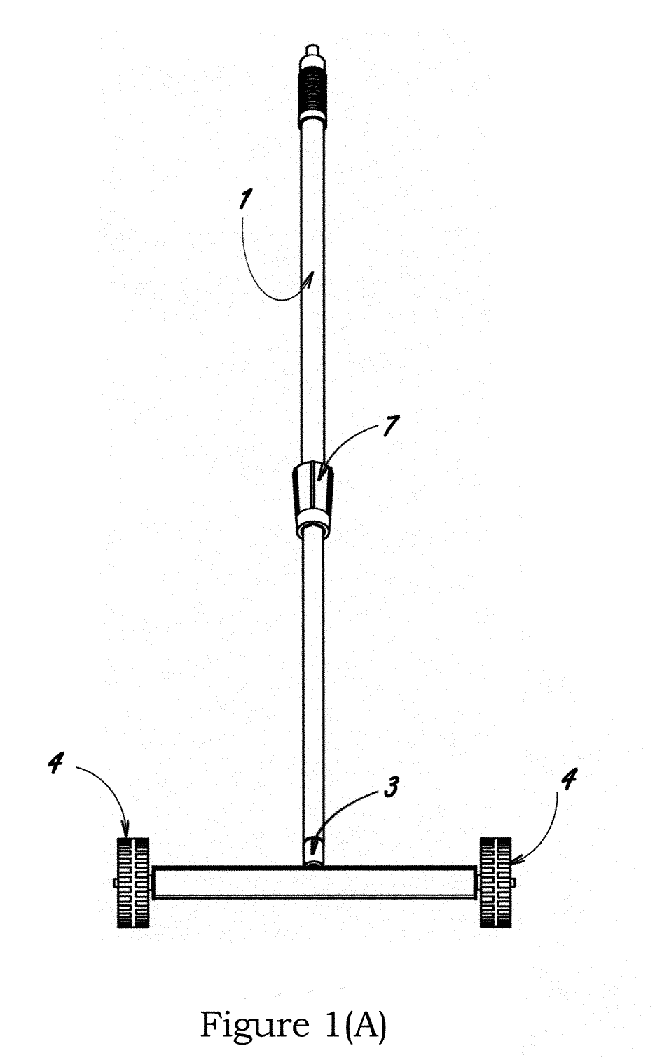

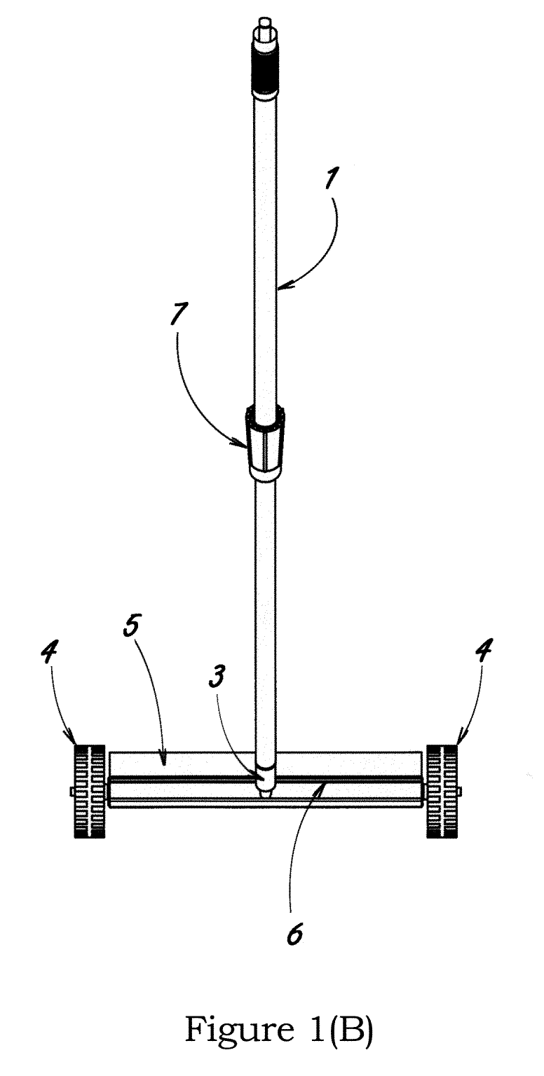

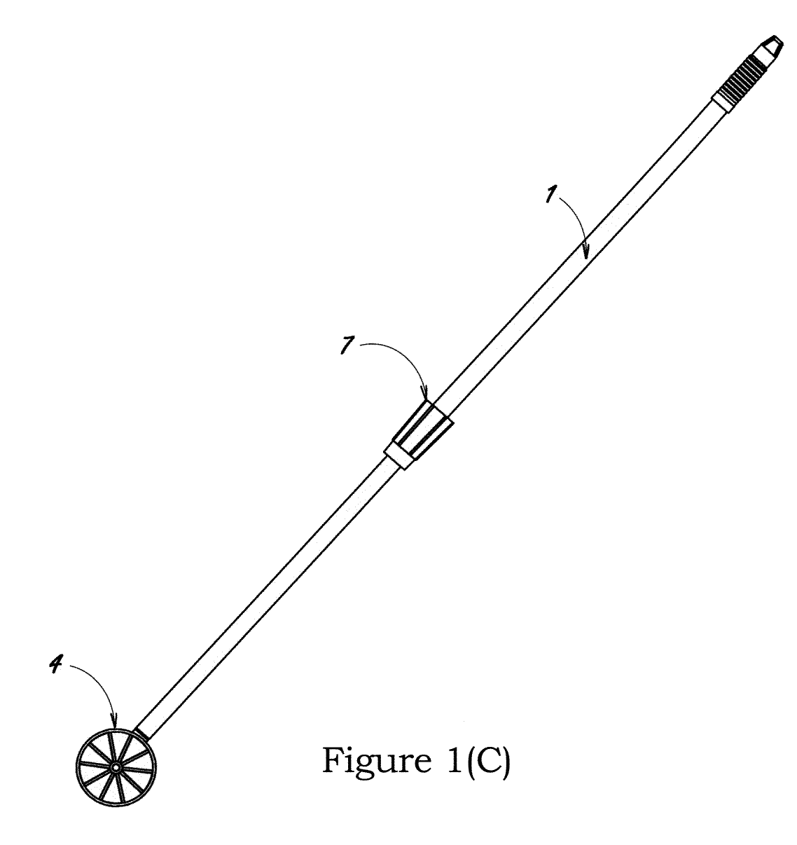

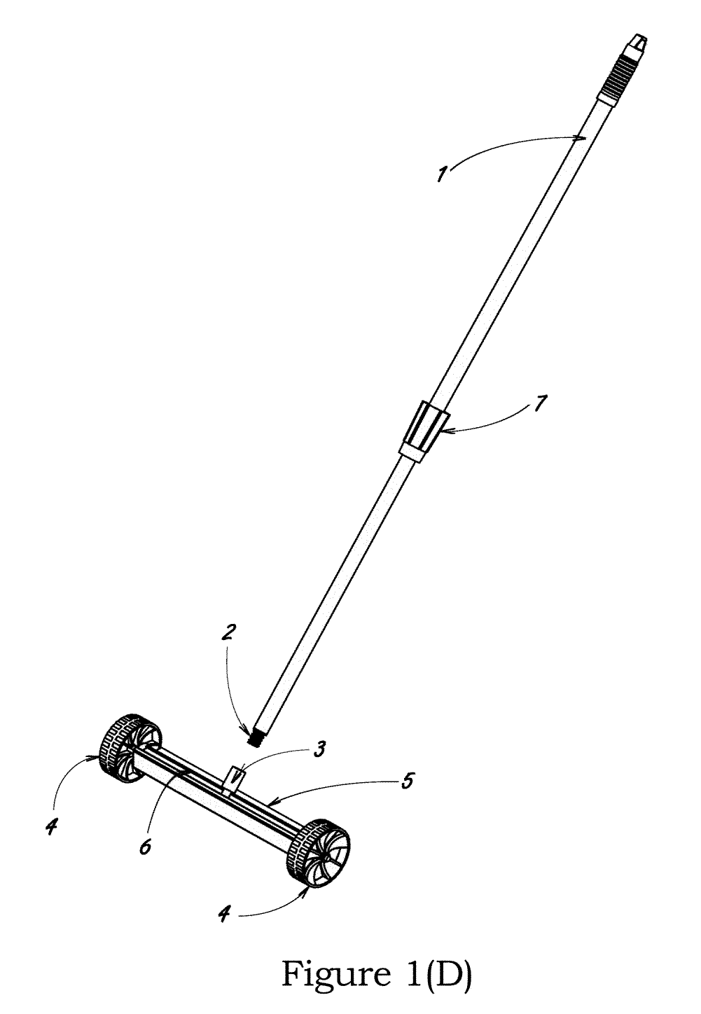

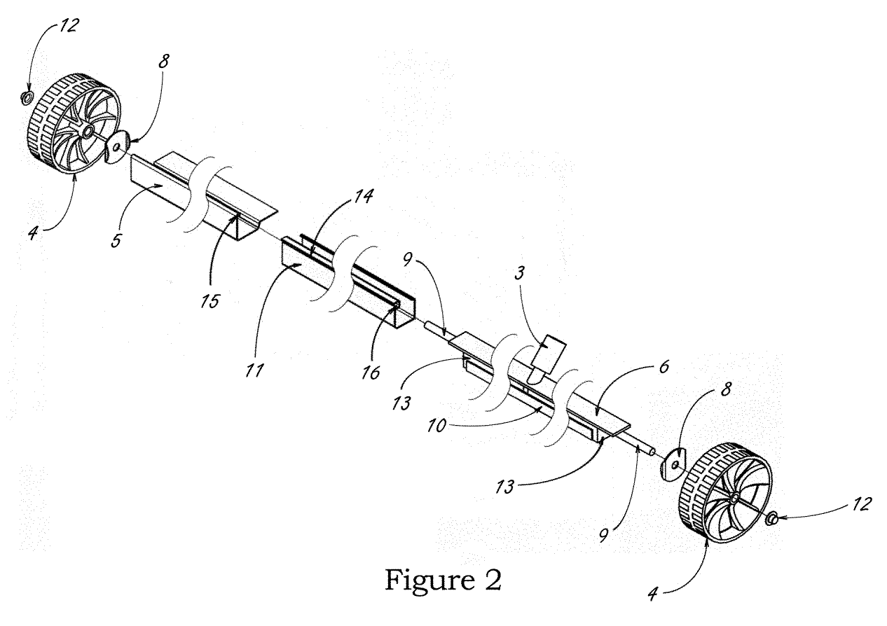

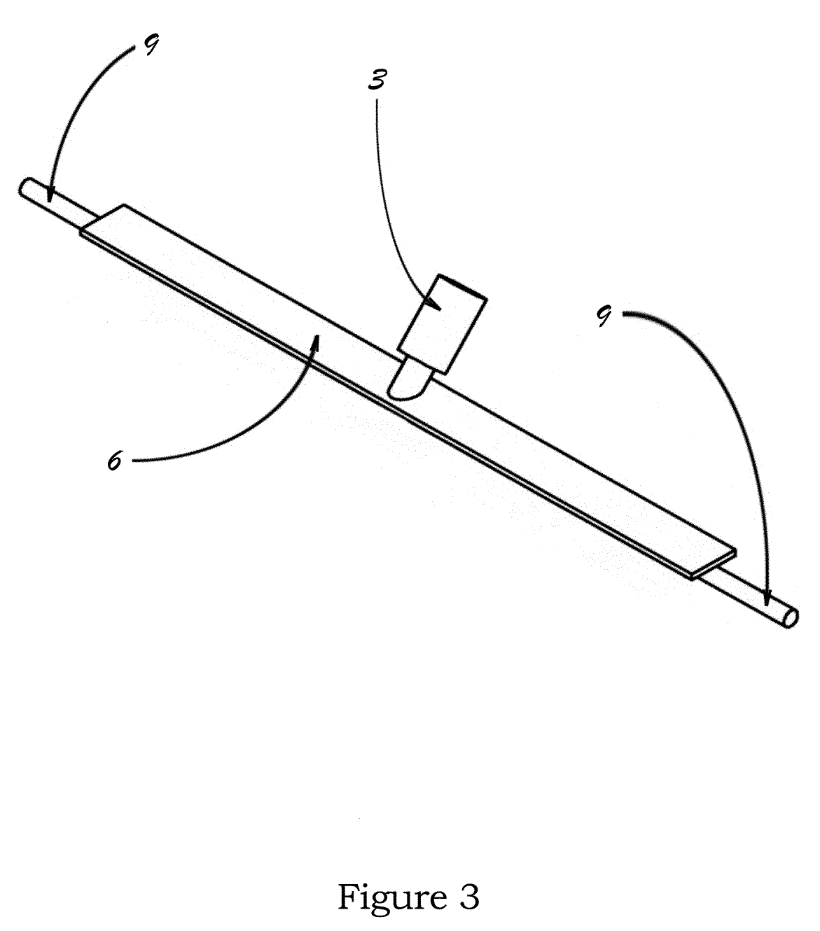

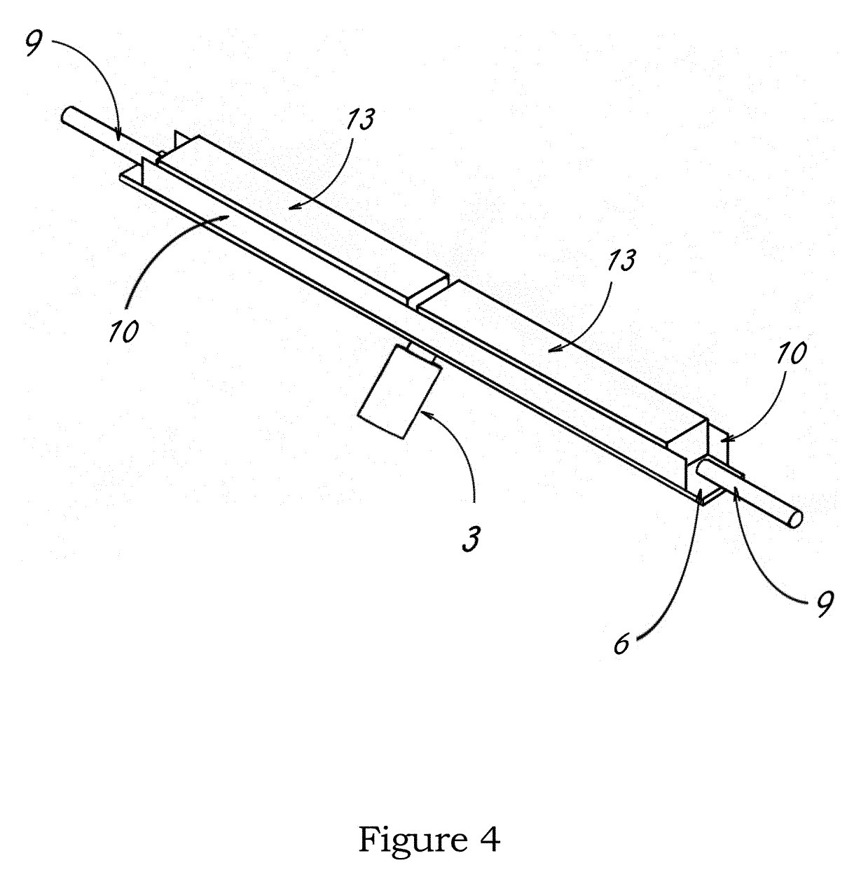

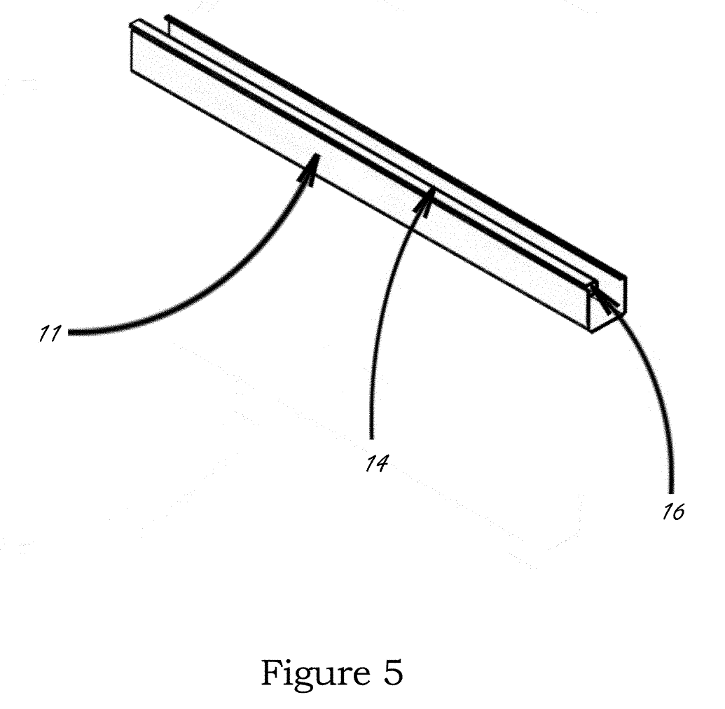

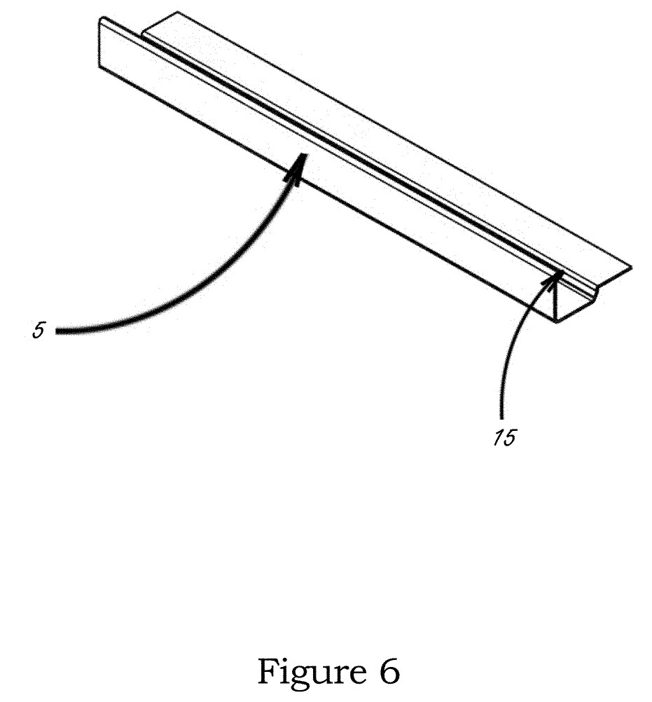

With reference to FIGS. 1(A-D), FIG. 2, there is illustrated a magnetic sweeper tool, which includes the main component parts consisting of a 14 inch long flat bar of steel 6 that acts as support for the axels 9 and doubles as a shield to focus the magnetic field in a downward direction. The right and left axles 9 are welded to the top plate 6 along with the ACME collar 3 and the total assembly FIG. 3 is zinc plated to protect the surface from the elements. Multiple ceramic magnets 13 are placed under the top-plate 6 and two additional magnetic shielding strips 10 are attached to the front and rear of the magnets 13 to help focus the magnetic field in a downward direction. This entire assembly FIG. 4 slides into the extruded channel 11, FIG. 5 as to house all parts FIG. 4. A portion of the extruded channel 11, which also doubles as a hinge 14, allowing for a “free-floating” release lever 5, FIG. 6 to pivot along the track portion 14 of the extruded housing 11 without mechanically fastening the two pieces, the extruded housing FIG. 5 and the ‘free-floating’-release lever FIG. 6, together.

Two specially formed “dirt washers” 8 are placed down the axles 9 covering the ends of the extruded channel FIG. 5 and the ‘free-floating’-release lever 5, FIG. 6, closing the ends and preventing dirt or debris from easily entering the sweeper unit FIGS. 1(A-D), FIG. 2. Two 4-inch plastic wheels 4 provide the proper ground clearance for the sweeper unit FIGS. 1(A-D), FIG. 2, to roll freely across various types of surfaces such as grass, gravel, sand, and multiple kinds of floor surfaces. Two push nut caps 12 are placed over the ends of the axles keeping the assembly FIG. 2 together, but also allowing to be removed for cleaning or easy replacement of any part or component.

The magnetic sweeper unit FIGS. 1(A-D), FIG. 2, has been specifically designed for the easy collection and release of various sized ferrous material. The main component FIGS. 1(A-D) that makes up the magnetic sweeper consists of an adjustable handle 1 with an outer tightening collar 7, that locks the handle, after adjusting, into the desired length.

The adjustable handle 1 connects to the main magnetic sweeper tool FIGS. 1(A-D) through a standard ACME screw. The magnetic sweeper tool FIG. 1(D) connects to the handle 1 by connecting the female counterpart (ACME collar) 3 to the ACME male counterpart 2 on the handle 1.

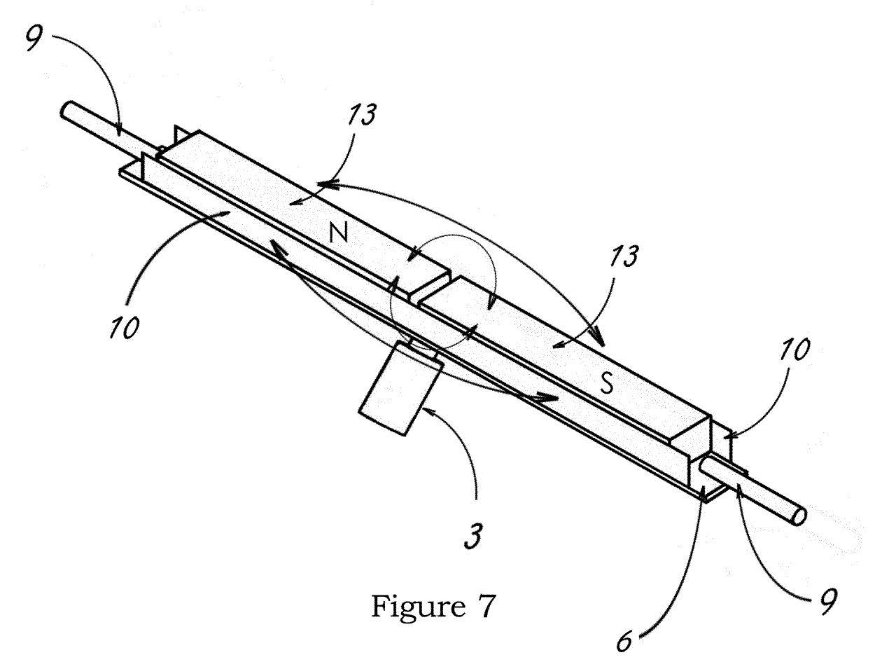

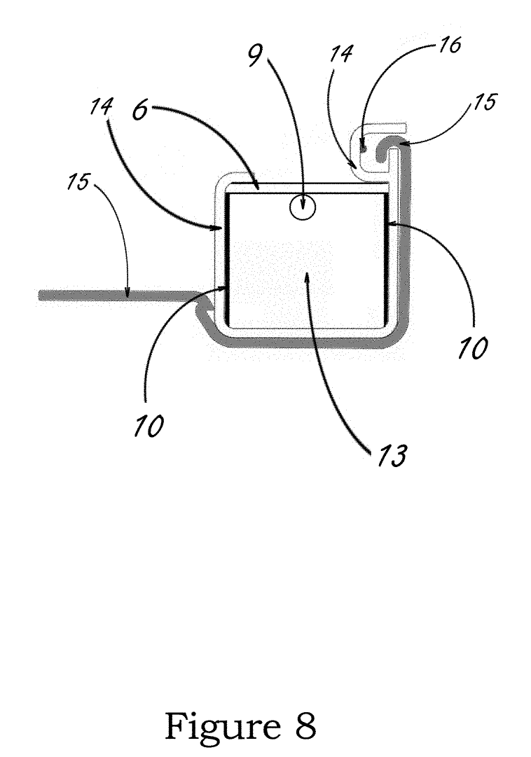

Use the magnetic sweeper FIGS. 1(A-D) by pushing the assembly in a forward and backward motion over a surface area to be cleaned off ferrous material. Once the magnetic sweeper unit FIGS. 1(A-D) has obtained the amount of ferrous materials desired to be collected and/or has reached the maximum holding capacity of the magnetic sweeper, the operator simply places the magnetic sweeper unit FIGS. 1(A-D) over a collection drop area to receive the ferrous material as it is released from the magnetic sweeper unit FIGS. 1(A-D). By simply pushing the “free-floating” release lever FIG. 6 downward by either hand, foot or otherwise away from the main body FIG. 2—and therefore away from the magnets 13—thereby creating a gap between the ferrous parts and the magnets 13, the ferrous material pieces are moved out of the magnetic field FIG. 7, and fall away by means of normal gravitational pull. The use of the magnetic sweeper FIGS. 1(A-D) can be recommenced and repeated as described above until all ferrous material parts have been ‘swept’ from the surface area.

### LEGEND

Number 1—Adjustable handle
Number 2—ACME male threaded handle
Number 3—ACME female collar
Number 4—ABS Plastic wheel (2)
Number 5—‘free-floating’-release lever
Number 6—Top-plate of the main body
Number 7—Tightening collar to lock handle
Number 8—‘Dust/dirt’ washer
Number 9—Left/Right axles
Number 10—Unplated steel strips
Number 11—Three-sided channel housing the main body
Number 12—Push nut caps
Number 13—Ceramic magnets (2)
Number 14—The ‘Track Portion’ of the extruded housing (Number 11—above)
Number 15—The ‘Hinge Portion’ of the ‘free-floating’-release lever (Number 5—above)
Number 16—The ‘Positioning Ridge’ to keep the track portion (Number 14—above) from binding while creating a fluid motion of the ‘free-floating’-release lever.

1. The invention is the three-sided extruded channel, that has an incorporated track for a free-floating hinged release lever. The release lever has been designed specifically as a means of easily removing ferrous material attracted by the three-sided channel, that allows to pass through the magnetic field from the magnets. As a means of incorporating minimal mechanical friction, the magnets are allowed to remain in a static position within the housing. A free-floating release lever is incorporated via a hinge into the extruded housing as to create a space gap between the magnetic field and the ferrous materials collected when operated. This allows for easy removal of the ferrous material without the operator having to be in direct contact with it.
